(19) United States
(12) Patent Application Publication
(10) Pub. No.: US 2004/0254795 A1
(43) Pub. Date: Dec. 16, 2004

(54) Speech input search system

(76) Inventors: Atsushi Fujii, Ibaraki (JP); Katsunobu Itoh, Ibaraki (JP); Tetsuya Ishikawa, Chiba (JP); Tomoyoshi Akiba, Ibaraki (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/484,386

(22) PCT Filed: Jul. 22, 2002
(86) PCT No.: PCT/JP02/07391

(30) Foreign Application Priority Data
Jul. 23, 2001 (JP) 2001-222194

(51) Int. Cl. G10L 11/00

(52) U.S. Cl. 704/277

(57) ABSTRACT

A language model 114 for speech recognition is developed from a text database 122 through offline modeling 130 (solid line arrow). A transcript is generated online by executing a speech recognition processing 110 using an acoustic model 112 and a language model 114 when a user utters a retrieval request. Next, a text retrieval processing 120 is executed using the transcribed retrieval request, and then outputs the retrieval results in order from the most relevant. Information is then acquired from the top-ranked texts of the retrieval results and is subjected to modeling 130, the speech recognition language model is refined (dotted line arrow), and speech recognition and text retrieval are then carried out again. This allows improvement in accuracy of recognition and retrieval compared to the initial retrieval.

### TECHNICAL FIELD

The present invention relates to speech input. In particular, it is related to a system that retrieves by speech input.

### BACKGROUND ART

Recent speech recognition technology can achieve practical recognition accuracy for utterances with contents organized to a certain degree. Furthermore, there exists commercial and free speech recognition software, which is supported by hardware technology development and operates on a personal computer. Therefore, introducing a speech recognition system into existing applications is relatively easy, and is believed to have ever growing demand.

Particularly, since information retrieval systems go back a long way and are one of the principal information processing applications, many studies of introducing speech recognition systems have been made over the years. These can be generally classified into the following two categories according to purpose.

Speech Data Retrieval

This is retrieval of broadcast speech data or the like. The inputting means thereof can be any type, but a text inputting means (e.g., keyboard) is mainly used.

Retrieval by Speech

A retrieval request (query) is made by speech input. The retrieval target form can be any type, but text is mainly used.

In other words, these differ in whether the retrieval target or the retrieval request is on a speech data basis. Furthermore, integrating the two allows implementation of speech data retrieval by speech input. However, there are very few such case studies at present.

Speech data retrieval is being actively studied under the backdrop of test collections of Text Retrieval Conference (TREC) spoken document retrieval (SDR) tracks for broadcast speech data being provided.

Meanwhile, retrieval by speech has very few case studies compared to speech data retrieval despite that it is a critical fundamental technology supporting applications not requiring keyboard input (barrier-free) such as car navigation systems and call centers.

As such, in a conventional system relevant to retrieval by speech, speech recognition and text retrieval typically exist as completely independent modules, merely being connected via an input/output interface. Furthermore, improvement in speech recognition accuracy is often not the subject of study, but rather the focus is on improvement in retrieval accuracy.

Barnett et al. (see J. Barnett, S. Anderson, J. Broglio, M. Singh, R. Iludson, and S. W. Kuo “Experiments in spoken queries for document retrieval” in Proceedings of Eurospeech 97 pp. 1323-1326, 1997) conducted evaluation experiments on retrieval by speech utilizing the existing speech recognition system (vocabulary size 20,000), which provides recognition results to a text retrieval system INQUERY. Specifically, a retrieval experiment on TREC collections was conducted using 35 (101-135) TREC retrieval items read aloud by a single speaker as test input.

Crestani (see F. Crestani, “Word recognition errors and relevance feedback in spoken query processing” in Proceedings of the Fourth International Conference on Flexible Query Answering Systems, pp. 267-281, 2000) has also conducted an experiment (typically applied to text retrieval) using the above-mentioned 35 items to be read aloud and retrieved, demonstrating improvement in retrieval accuracy through relevance feedback. However, since the existent speech recognition system is utilized unreformed in either experiment, the word error rate is relatively high (30% or higher).

A statistical speech recognition system (see Lalit. R. Bahl, Fredrick Jelinek, and L. Mercer, “A maximum likelihood approach to continuous speech recognition” IEEE Transactions on Pattern Analysis and Machine Intelligence, vol. 5, no. 2, pp. 179-190, 1983, for example) is mainly configured of an acoustic model and a language model, where both strongly affect speech recognition accuracy. The acoustic model is a model relevant to acoustic properties and an independent item of to-be-retrieved texts.

The language model is a model for quantifying the linguistic relevance of the speech recognition results (candidates). However, since modeling all language phenomena is impossible, a model specialized for language phenomena occurring in a provided learning corpus is typically created.

Increasing the accuracy of speech recognition is also important to progress interactive retrieval smoothly, as well as provide the user with a sense of security that the retrieval is being executed based on the request as spoken.

In the conventional system relevant to retrieval by speech, speech recognition and text retrieval typically exist as completely independent modules, merely being connected via an input/output interface. Furthermore, improvement in speech recognition accuracy is often not the subject of study, but rather the focus is on improvement in retrieval accuracy.

### DISCLOSURE OF INVENTION

An objective of the present invention is to improve accuracy in both speech recognition and information retrieval by focusing on organic integration of speech recognition and text retrieval.

In order to achieve the above-mentioned objective, the present invention is a speech input retrieval system, which retrieves in response to a query input by speech, including: a speech recognition means, which performs speech recognition of the query input by speech using an acoustic model and a language model; a retrieval means, which searches a database in response to the query input by speech; and a retrieval result display means, which displays the retrieval results, wherein the language model is generated from the database for retrieval targets.

The language model is regenerated with retrieval results from the retrieval means, the speech recognition means re-performs speech recognition in response to the query using the regenerated language model, and the retrieval means conducts a retrieval once again using the query to which speech recognition has been re-performed.

Accordingly, the speech recognition accuracy may be further improved.

The retrieval means calculates the matching degree with the query and outputs in order from the highest matching degree, and already established retrieval results with high matching degree are used when regenerating the language model with the retrieval results from the retrieval means.

A computer program that allows integration of these speech input retrieval systems in a computer system, and a recording medium that is recorded with this program are also the present invention.

### BRIEF DESCRIPTION OF DRAWINGS

FIG. 1 is a diagram illustrating an embodiment of the present invention.

### BEST MODE FOR CARRYING OUT THE INVENTION

Hereinafter, an embodiment of the present invention is described while referencing the drawing.

With a retrieval system dealing with speech input, chances are high that a user's utterance has content relevant to a retrieval target text. If a language model is then created based on the retrieval target text, improvement in speech recognition accuracy can be anticipated. As a result, the user's utterance is accurately recognized, allowing retrieval accuracy close to the text input.

Increasing the accuracy of speech recognition is also important to progress interactive retrieval smoothly as well as provide the user with a sense of security that the retrieval is being executed based on the request as spoken.

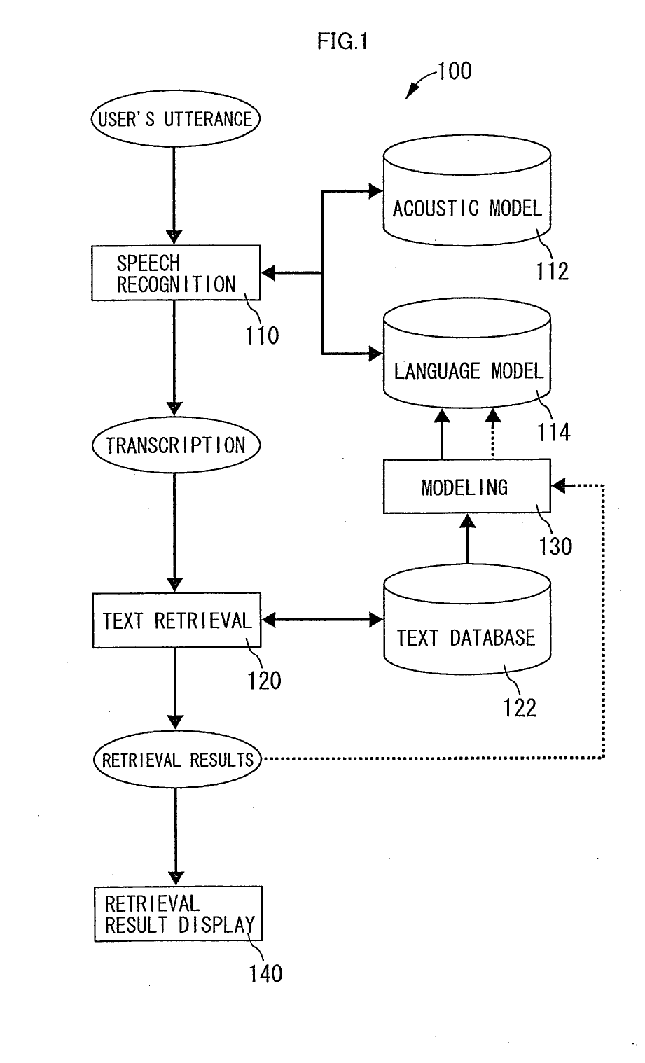

The configuration of a speech input retrieval system 100 according to the embodiment of the present invention is shown in FIG. 1. This system is featured by an organic integration of speech recognition and text retrieval with increased speech recognition accuracy based on the retrieval text. To begin with, a language model 114 for speech recognition is created from a text database 122 for retrieval, through offline modeling 130 (solid line arrow).

On the other hand, a transcript is generated online by executing a speech recognition processing 110 using an acoustic model 112 and a language model 114 when a user utters a retrieval request. Actually, multiple transcript candidates are generated, and the candidate maximizing likelihood is selected. Here, since the language model 114 has been developed based on the text database 122, the fact that the transcript linguistically similar to the text within the database is selected with high priority should receive attention.

Next, a text retrieval processing 120 is carried out using a transcribed retrieval request, and then outputs the retrieval results in order from the most relevant.

The retrieval results may be displayed at this time by a retrieval result display processing 140. However, since the speech recognition results may contain errors, the retrieval results also include information not relevant to the user's utterance. Meanwhile, since relevant information to the accurately recognized utterance portions is also retrieved, the information density of the retrieval results relevant to the user's retrieval request is high in comparison with the entire text database 122. Information is then acquired from the top-ranked texts of the retrieval results and is subjected to modeling 130, refining the speech recognition language model (dotted line arrow). Speech recognition and text retrieval are then carried out again. This allows improvement in accuracy of recognition and retrieval compared to the initial retrieval. This retrieved content with improved speech recognition and retrieval accuracy is presented to the user in the retrieval result display processing 140.

It should be noted that this system is described with an example where Japanese is the target, however, in theory, the target language does not matter.

Hereafter, speech recognition and text retrieval are respectively described.

<Speech Recognition>

The Japanese dictation basic software from the Continuous Speech Recognition Consortium (see ed. K. Shikano et al., “Speech Recognition System”, Ohmsha, 2001, for example) may be used for speech recognition. This software is capable of 90% recognition accuracy with close to real-time operation running with a 20,000-word dictionary. The acoustic model and a recognition engine (decoder) are utilized even without modifying this software.

Meanwhile, a statistical language model (word N-gram) is developed based on the retrieval target text collection. Usage of related tools attached to the aforementioned software and/or the generally available Morphological analysis system ‘ChaSen’ together with this system allows relatively easy development of a language model for various targets. In other words, a highly frequent word limited model is configured by pre-processing such as deleting unnecessary portions from the target text, segmenting them into morphemes using ‘ChaSen’, and considering reading thereof (regarding this processing, see K. Ito, A. Yamada, S. Tenpaku, S. Yamamoto, N. Todo, T. Utsuro, and K. Shikano, “Language Source and Tool Development for Japanese Dictation,” Proceedings of the Information Processing Society of Japan 99-SLP-26-5, 1999).

<Text Retrieval>

A probabilistic method may be used for text retrieval. This method is demonstrated through several recent evaluation tests to achieve relatively high retrieval accuracy.

When a retrieval request is made, the matching degree with each text within the collection is calculated based on the index term frequency distribution, outputting from the best matching text. The matching degree with text i is calculated with Expression (1).

$${\sum }_{t}^{} ( \frac{{TF}_{t , i}}{\frac{{DL}_{i}}{avglen} + {TF}_{t , i}} log \frac{N}{{DF}_{t}} ) \qquad ( 1 )$$

where t denotes an index term contained in the retrieval request (in this system, it is equivalent to the transcription of the user's utterance). TF_{t,i} denotes the frequency of occurrence of the index term t in text i. DFₜ denotes the number of texts that contain the index term t within the target collection, and N denotes the total number of texts within the collection. DLᵢ denotes the document length (number of bytes) of text i, and avglen denotes the average length of all texts within the collection.

Offline index term extraction (indexing) is necessary in order to properly calculate the matching degree. Consequently, word segmentation and addition of parts of speech are performed using ‘ChaSen’. Furthermore, content terms (mainly nouns) are extracted based on parts of speech information and each term is indexed so as to create a transposed file. Index terms are extracted online through the same processing as that for the transcribed retrieval request and are then used for retrieval.

An example implementing the system of the embodiment described above is described taking as an example document abstract retrieval using the text database as the document abstract.

The utterance ‘jink\overline{o}chin\overline{o} no sh\overline{o}gi eno \overline{o}y\overline{o}’ is taken as an example. It is assumed that this utterance has been erroneously recognized through the speech recognition processing 110 as ‘jink\overline{o}chin\overline{o} no sh\overline{o}hi eno \overline{o}y\overline{o}’. However, as for the retrieval result of the document abstract database, the accurately recognized ‘jink\overline{o}chin\overline{o}’ becomes a valid keyword, and the following list of document titles in order from the best matching title is retrieved.

1. \overline{O}y\overline{o}men karano rironky\overline{o}iku jink\overline{o}chin\overline{o}

2. Am\overline{u}zumento eno jink\overline{o}seimei no \overline{o}y\overline{o}

3. Jissekaichin\overline{o} o mezashite (II).metafa ni motozuku jink\overline{o}chin\overline{o}

______

29. Sh\overline{o}gi no joban ni okeru j\overline{u}nan na komakumi notameno hitoshuh\overline{o} (2)

______

The document relevant to the desired phrase ‘jink\overline{o}chin\overline{o} sh\overline{o}gi’ first appears in this list of retrieval results as the twenty-ninth entry. Therefore, if these results are presented as is to the user, it is time consuming for the user to reach the relevant document. However, when instead of immediately presenting this result a language model is acquired using higher ranked document abstracts from a ranking list (for example, the top 100) of the retrieval results, speech recognition accuracy for the user's spoken words (namely, ‘jink\overline{o}chin\overline{o} no sh\overline{o}gi eno \overline{o}y\overline{o}’) improves, and proper voice recognition is then carried out through performing speech recognition again.

As a result, the subsequent retrieval is as given below, where documents relevant to ‘jink\overline{o}chin\overline{o} sh\overline{o}gi’ are ranked in the top entries.

1. Sh\overline{o}gi no joban ni okeru j\overline{u}nan na komakumi notameno hitoshuh\overline{o} (2)

2. Sairy\overline{o} y\overline{u}senkensaku niyoru sh\overline{o}gi no sashiteseisei no shuh\overline{o}

3. Konp\overline{u}ta sh\overline{o}gi no genjo 1999 haru

4. Sh\overline{o}gi puroguramu niokeru joban puroguramu no arugorizumu to jiss\overline{o}

5. Meijin ni katsu sh\overline{o}gi shisutemu ni mukete

______

In this manner, speech recognition may be improved by reflecting the learning results of the retrieval target on the language model for speech recognition beforehand, or learning results of the retrieval of the user's speech content on the same. Learning for every repeated retrieval allows improvement in the speech recognition accuracy.

It should be noted that the top 100 retrieval results were used in the description given above, however, for example, a threshold may be provided to the matching degree, and the retrieval results above that threshold may be used.

### INDUSTRIAL APPLICABILITY

As described above, due to the configuration of the present invention, since speech recognition accuracy for speech relevant to a text database that is the retrieval target improves, and the speech recognition accuracy gradually improves in real time for every repeated search, highly accurate information retrieval by speech can be achieved.

1. (Canceled)

2. A speech input retrieval system, which retrieves in response to a query input by speech, comprising:
a speech recognition means, which performs speech recognition of the query input by speech using an acoustic model and a language model that is generated from a retrieval target database;
a retrieval means, which searches a database in response to the query to which speech recognition has been performed;
a retrieval result display means, which displays the retrieval results; and
a language model generation means, which regenerates the language model with retrieval results from the retrieval means,
wherein
the speech recognition means re-performs speech recognition in response to the query using the regenerated language model, and
the retrieval means conducts a retrieval once again using the query to which speech recognition has been re-performed.

3. The speech input retrieval system of claim 2, wherein,
the retrieval means calculates the matching degree with the query and outputs in order from the highest matching degree, and
the language model generation means uses already established retrieval results with high matching degree when regenerating the language model with the retrieval results from the retrieval means.

4. A recording medium that is recorded with a computer program, which allows integration of the speech input retrieval system of claim 2 in a computer system.

5. A computer program, which allows integration of the speech input retrieval system of claim 2 in a computer system

6. A recording medium that is recorded with a computer program, which allows integration of the speech input retrieval system of claim 3 in a computer system.

7. A computer program, which allows integration of the speech input retrieval system of claim 3 in a computer system.
